(19) United States
(12) Patent Application Publication
(10) Pub. No.: US 2007/0182045 A1
(43) Pub. Date: Aug. 9, 2007

(54) Method for foaming of refrigerator cabinet with uniform density by feedback control and foaming system used thereof

(75) Inventors: Sang-Eui Hong, Gyeongsangnam-Do (KR); Gyeong-Do Kim, Busan (KR); Young-Bae Kim, Busan (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/346,170

(22) Filed: Feb. 3, 2006

(51) Int. Cl. B29C 44/18

(52) U.S. Cl. 264/40.1; 264/46.4; 425/4 R; 425/143

(57) ABSTRACT

A method for forming foam within a refrigerator cabinet by feedback controlling and a foaming system used for the method are provided to form blowing foam with uniform density. Allowable range of each of parameters, which critically affect the blowing foam quality of the refrigerator cabinet, allowing formation of the blowing foam with the uniform density within the refrigerator cabinet is obtained through experimentation and set in advance, and before forming the blowing foam within the refrigerator cabinet, each parameters are measured to check whether a measured value is within the allowable range. If the measured value does not come within the allowable range, it is controlled to come within the allowable range by using the controlling unit and then the blowing foam is filled and formed within the refrigerator cabinet. By doing that, the reliable blowing foam with high quality and uniform density can be formed.

### BACKGROUND OF THE INVENTION

1. Field of the Invention

The present invention relates to a method for foaming a refrigerator cabinet and a foaming system and, more particularly, to a method for foaming the insulation portion of the refrigerator cabinet with uniform density so as to obtain excellent insulation effect by a feedback control, and a foaming system used for the method.

2. Description of the Related Art

The refrigerator keeps food items in storage at a low temperature, which includes a cabinet configuring a receiving space such as a refrigerating chamber or a freezing chamber for receiving food items, a door for opening or closing the refrigerating chamber and the freezing chamber, and a mechanical part including a refrigerating cycle to maintain the received food items at the low temperature state.

As for the cabinet, in order to increase refrigeration maintaining effect, an insulation material is filled between an outer surface forming an outer appearance of the refrigerator and an inner surface thereof forming the receiving space. Recently, polyurethane is being typically employed as the insulation material because polyurethane is light and has excellent insulation characteristics. The insulation material is filled inside the cabinet such that a polyurethane blowing agent as liquid state is injected between the inner and outer surfaces of the assembled cabinet and then heated to be blown to form a polyurethane foam.

FIGS. 1 to 5 show the construction of a foaming device of the refrigerator cabinet and a process of foaming using a polyurethane blowing agent by the foaming device.

As shown in FIGS. 1 and 2, the foaming device 1 of the refrigerator cabinet includes a base plate 10 supporting an overall load, a support unit 20 for closing up/down, left/right and front/back sides in a state that the refrigerator cabinet is installed therein, a core unit 30 formed in the same shape as the inner surface of the cabinet, and a fan 40 for sucking external cold air into the core unit 30 to prevent the core unit 30 from being overheated.

The base plate 10 includes an upper plate 11, a lower plate 12, reinforcing members 13 formed between the upper and lower plates 11 and 12 to support the most elements of the foaming device 1 of the refrigerator cabinet, fork insertion holes 14 formed between the reinforcing members 13 to allow a fork of a forklift to be inserted therein to facilitate transportation of the foaming device 1 of the refrigerator cabinet by the forklift, and a plurality of hinge units 15 formed on the upper plate 11 and rotating the support unit 20 by a hinge mechanism 15a to open it.

The support unit 20 includes front/back/left/right support plates 21, 22, 23 and 24 for hermetically closing the refrigerator cabinet 99 such that it can tolerate a blowing pressure of the blowing agent (i.e., a polyurethane liquid foaming solution) in a state that the refrigerator cabinet 99 is installed to cover the core unit 30, an upper surface support plate 25 formed to hermetically close the upper surface of the cabinet 99 with the rear support plate 22 and the hinge mechanism 15a, and a bottom support plate 26 integrally formed with the core unit 30 and forming a bottom surface.

Herein, the side support plates comprising the front/back/left/right support plates 21˜24 are operated to be pursed and opened to insert or take out the cabinet 99 by means of the hinge units 15.

The core unit 30 Includes a refrigerating chamber core 31 made of an aluminum material having excellent heat conductivity according to the shape of the inner surface of the refrigerating chamber of the cabinet and a freezing chamber core 32 made of the aluminum material according to the shape of an inner surface of the freezing chamber of the cabinet so that the cabinet 99 can be mounted in the foaming device 1 of the refrigerator cabinet, and maintains the shape of the inner surface of the refrigerator cabinet against a blowing pressure generated when the polyurethane blowing agent is blown.

During heating the blowing agent injected into the refrigerator cabinet so as to blow the blowing agent, in order to prevent the core unit 30 from being overheated, the fan 40 forcibly releases heat of the core unit 30 by injecting cold air from an external blowing duct 41 through an internal blowing duct 42. In this case, it may be preferred that the internal blowing duct 42 for injecting cold air is disposed at the center of the core unit 30, but due to a limitation of the blowing pressure and an interference of the structure of the bottom support 26, the blowing duct 42 is positioned at both end portions 33 of the core unit 30.

The process of filling the blowing foam within a pre-assembled refrigerator cabinet 99 whose outer surface and Inner surface have been coupled by using the foaming device 1 of the refrigerator cabinet constructed as described above will be explained.

As shown in FIGS. 3 to 5, the foaming device 1 of the refrigerator cabinet forms flowing foam within the refrigerator cabinet while passing through a heating region along a process in a direction of an arrow on a belt 51.

In detail, at a stage P1, the upper support plate 25 is rotated by means of the hinge unit 27 with respect to the back support plate 22 so as to be opened, and then, the front/back/left/right support plates 21˜24 are rotated with respect to the base plate 10 by means of the hinge unit 15 so as to be opened. As the foaming device 1 is rotated one time in the direction of the arrow in FIG. 4, blowing inside the refrigerator cabinet is completed. The blowing-completed refrigerator cabinet is separated at a stage P2, another refrigerator cabinet to undergo a process of forming of blowing foam is inserted so as to be engaged with the core unit 30 formed according to the shape of the inner surface of the cabinet at a stage P3, and then, the support plates 21˜25 are closed to hermetically cover the refrigerator cabinet.

Thereafter, a polyurethane blowing agent is injected by using a blowing agent injecting unit 60 through blowing agent injection openings 25a of the foaming device 1 of the refrigerator cabinet. And then, the foaming device 1 of the refrigerator cabinet is led into shaded B and C heating regions.

As shown in FIG. 3, when the foaming device 1 of the refrigerator cabinet is positioned within an insulation wall 50 of an oven, a heating device, it passes through the heating regions while the support units 20 are being heated by an external heater. During this process, the temperature (TI) of the blowing agent and the temperature (Tc) of the refrigerator cabinet 99 mainly affect forming quality of blowing foam of the polyurethane blowing agent according to the amount (Q) of the blowing agent injected per unit time. Thus, if the temperatures (TI and Tc) are not within an allowable range when the blowing foam is filled and formed in the refrigerator cabinet 99, density of the blowing foam would not be uniform. The non-uniformity of the blowing foam filled in the refrigerator cabinet would degrade the insulation efficiency of the refrigerator cabinet 99, manufacturing a defective product, and in this respect, unless the blowing foam-formed refrigerator cabinet is cut and inspected, whether or not the filled blowing foam has been formed with non-uniform density cannot be known, if the product is on the market without undergoing the inspection as usual, there is a high possibility that its recognition by consumers would be inevitably degraded.

Therefore, the need for reliably filling blowing foam in the refrigerator cabinet 99 with uniform density is increasing.

### BRIEF DESCRIPTION OF THE INVENTION

Therefore, one object of the present invention is to provide a method for forming foam with uniform density within a refrigerator cabinet by feedback controlling and a foaming system used for the method.

Another object of the present invention is to manufacture a refrigerator cabinet having excellent insulation effect with reliable blowing foam with uniform density formed therein, for which blowing foam does not need to be inspected to be checked in its state after being formed within the refrigerator cabinet.

To achieve these and other advantages and in accordance with the purpose of the present invention, as embodied and broadly described herein, there is provided a method for forming foam of a refrigerator cabinet including a process of putting a refrigerator cabinet in a foaming device, injecting a blowing foam solution thereinto and blowing, comprising: obtaining an allowable range of a parameters with respect to securing good blowing foam quality of the refrigerator cabinet; inputting and setting the allowable range of the parameters; measuring the parameters with the refrigerator cabinet insertedly installed In the foaming device; comparing a measured value of the parameters with the allowable range to check whether the measured value is within the allowable range of the parameters; injecting a blowing agent (i.e., a polyurethane liquid foaming solution) into the refrigerator cabinet when the measured value of the parameters are within the allowable range; and controlling the measured value of the parameters if it is not within the allowable range.

That is, referring to the parameters which critically affect the foaming process of the refrigerator cabinet, the allowable range of each parameters for allowing formation of the blowing foam with uniform density is previously obtained and stored in a database form and the parameters are measured often (as necessary) to check whether it is outside the allowable range, and if the parameters are outside the allowable range, the parameters are controlled by using a temperature of pressure controlling device and then the blowing process is performed in order to form blowing foam with uniform and desired density within the refrigerator cabinet.

Herein, in the comparing step, if the measured value of the parameters is outside the allowable range, the measuring step is performed again to check whether the parameters are within the allowable range frequently to thereby form reliably blowing foam with good quality.

The parameters may refer to temperature (TI) of the blowing agent, temperature (Tc) of the refrigerator cabinet, and pressure (Pc) of the refrigerator cabinet which critically affect forming of the blowing foam.

The temperature (Tc) of the refrigerator cabinet can be obtained by indirectly inferring upon measuring temperature (Tj) of the foaming device from a surface of a support unit contacting with the refrigerator cabinet or from a surface of a core unit, and also can be directly measured by using a temperature sensor insertedly installed within the refrigerator cabinet.

The temperature (TI) of the blowing agent or the temperature (Tc) of the refrigerator cabinet is controlled by a blowing agent injection opening or by a heat line or a blowing fan installed near the refrigerator cabinet.

The volume rate of flow (Q) of the blowing agent injected per given time is controlled by a valve.

If the measured temperature is not within the allowable range, a warning message informing that the measured temperature is not within the allowable range is displayed in the comparison step for operator's reference, or according to the circumstances, the forming process can be immediately suspended to prevent the blowing foam from being filled and formed with non-uniform density within the refrigerator cabinet.

Effectively, the method for forming foam of a refrigerator cabinet can further comprise: measuring pressure (Pc) of the refrigerator cabinet following the blowing agent injecting step; checking whether the measured pressure (Pc) is within allowable range; and controlling the volume rate of flow (Q) of the blowing agent injection unit if the measured pressure (Pc) is not within the allowable range.

To achieve the above object, there is also provided a system for forming foam within a refrigerator cabinet by feedback controlling comprising: a support unit for supporting an outer wall of the refrigerator cabinet; a core unit for supporting an inner wall of the refrigerator cabinet; a blowing agent injection unit for injecting a blowing agent into the refrigerator cabinet; a temperature sensor installed at one of one surface of the support unit contacting with the outer wall of the refrigerator cabinet and one surface of the core unit contacting with the inner wall of the refrigerator cabinet; a blowing agent temperature sensor installed at the blowing agent injection unit; a pressure sensor for measuring a blowing pressure within the refrigerator cabinet; a controller for checking whether values measured by the sensors are within allowable range; and a controlling unit for controlling temperature and pressure of the blowing agent and those within the refrigerator cabinet, wherein if the values measured by the sensors are not within the allowable range, the temperature and pressure are controlled by the controlling unit.

A through hole is formed at the refrigerator cabinet, and the pressure sensor is protruded from a surface of the support unit, so that when the refrigerator cabinet is installed in the foaming system, the pressure sensor is positioned inside the refrigerator cabinet. Through the pressure sensor, the blowing pressure within the refrigerator cabinet can be accurately measured. The through hole of the refrigerator cabinet through which the pressure sensor is inserted can be covered by attaching a sticker after the forming process is completed. The pressure sensor can be repeatedly used several times.

The temperature controlling unit can be formed as a heat line formed therearound and a fan for blowing cold air, and the pressure controlling unit is formed as a valve for controlling the flow quantity of the blowing agent. With these controlling units, when the value measured by the pressure sensor is not within the allowable range, flow velocity of the blowing agent can be changed by controlling the opening/closing degree of the valve.

The foregoing and other objects, features, aspects and advantages of the present invention will become more apparent from the following detailed description of the present invention when taken In conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a foaming device of a refrigerator cabinet in accordance with a related art;

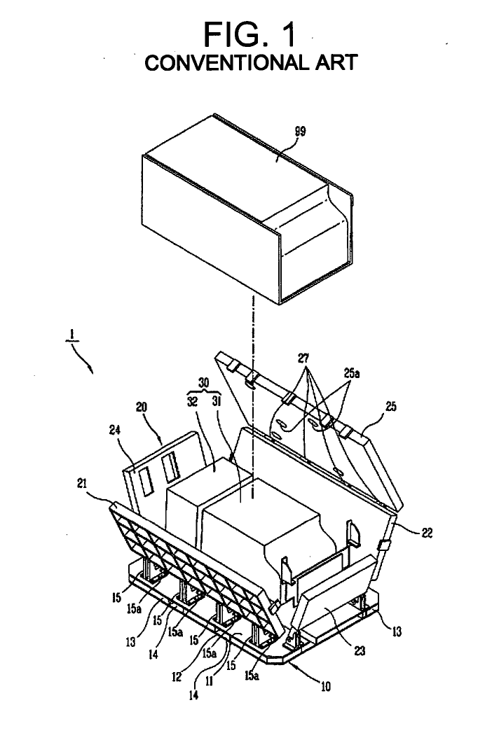

FIG. 2 is a perspective view showing a blowing agent is injected into the foaming device of FIG. 1 in accordance with the related art;

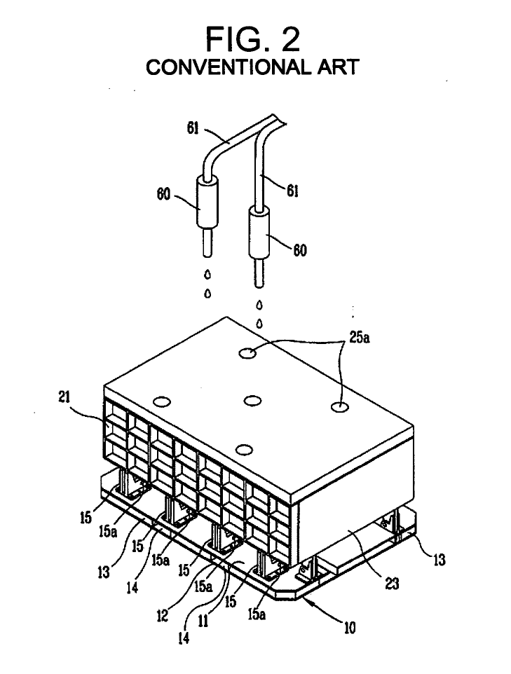

FIG. 3 is a side sectional view showing the construction of a blowing process by using the foaming device of FIG. 1 in accordance with the related art;

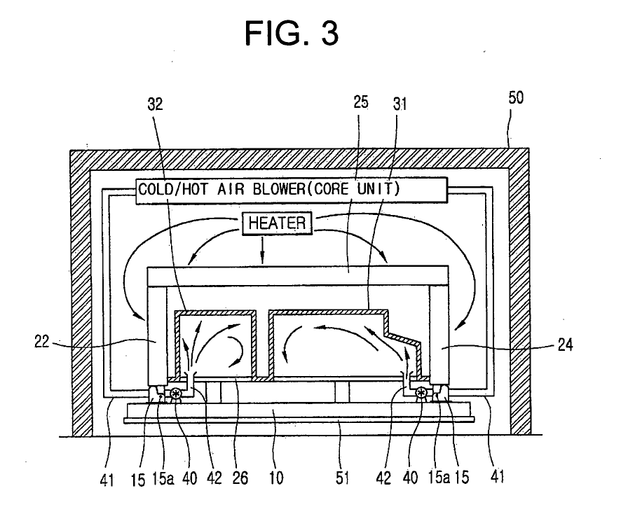

FIG. 4 is shows the construction of a heating process using the foaming device;

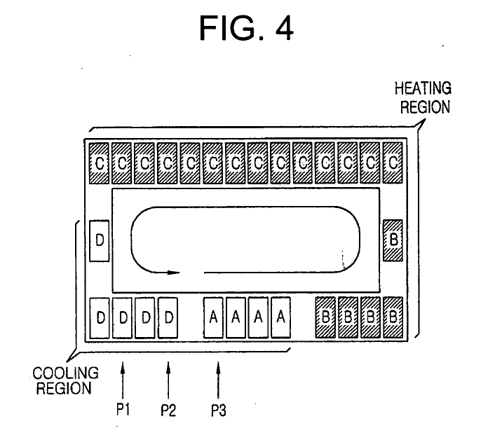

FIG. 5 is a flow chart illustrating the foamingprocess using the foaming device in accordance with the related art;

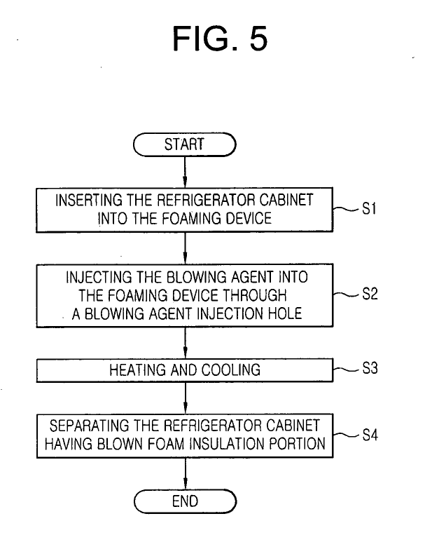

FIG. 6 shows the construction of a system for forming foam within a refrigerator cabinet by feedback controlling in accordance with the present invention; and

FIG. 7 is a flow chart illustrating the method for forming foam within the refrigerator cabinet according to feedback controlling by using the foaming system of FIG. 6 in accordance with the present invention.

### DETAILED DESCRIPTION OF THE INVENTION

The present invention will now be described in detail with reference to the accompanying drawings.

In describing the present invention, detailed descriptions with respect to a known function or construction will be omitted to make the gist of the present invention clear.

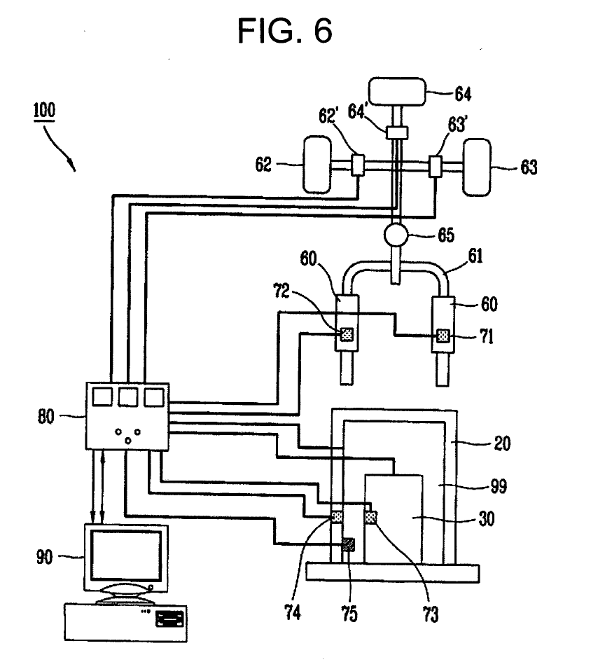

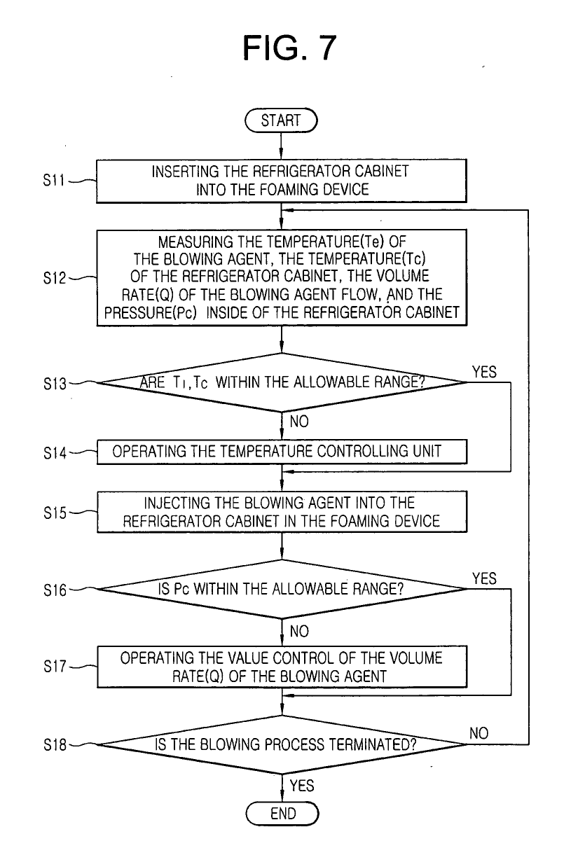

FIG. 6 shows the construction of a system for forming foam within a refrigerator cabinet by feedback controlling in accordance with the present invention and FIG. 7 is a flow chart illustrating the method for forming foam within the refrigerator cabinet according to feedback controlling by using the foaming system of FIG. 6 in accordance with the present invention.

As shown in FIG. 6, the system 100 for forming foam within a refrigerator cabinet 99 includes: a base plate 10 supporting an overall load; a support unit 20 for closing up/down, left/right and front/back sides in a state that the refrigerator cabinet is installed therein; a core unit 30 formed in the same shape as the inner surface of the cabinet; a fan 40 for injecting external cold air to prevent the core unit 30 from being overheated; temperature sensors 71-74 installed at positions critically affecting formation of blowing foam within the refrigerator cabinet 99, a pressure sensor 75 attached to be protruded at the support unit 20 to measure pressure of the refrigerator cabinet 99: a controller 80 for previously storing an allowable range of parameters allowing forming of the blowing foam with uniform density within the refrigerator cabinet 99 in a database form, receiving measured values from the temperature sensors 71-74 and the pressure sensor 75 and comparing them; a heat line (not shown) formed at the support unit 20 and the core unit 30 to heat the refrigerator cabinet 99 when the measured value of the temperature sensors 71-74 is lower than the lower limit value of the allowable range; valves 62′, 63′ and 64′ for controlling a flow quantity of a polyurethane blowing agent injected into the refrigerator cabinet 99; and an alarm unit 90 for displaying a warning message if the measured value of the temperature sensors 71-74 and the pressure sensor 75 exceeds the allowable range.

Herein, in order to make the polyurethane blowing agent blown by a chemical reaction, temperature around the polyurethane blowing agent must maintain 45° C.±5° C., higher than a room temperature, so it is quite important to maintain the temperature (Tc) of the refrigerator cabinet in the foaming system and the temperature (TI) of the blowing agent. Thus, in order to measure the temperature (TI) of the blowing agent injected from the blowing agent injection unit 60 and the temperature (Tc) within the refrigerator cabinet 99, the temperature sensors 71-74 are installed at the opening of the blowing agent injection unit 60, the core unit 30 and each surface of side support plates 21-24.

The temperature (Tc) of the refrigerator cabinet and the temperature (TI) of the blowing agent are frequently measured by using the temperature sensors 71-74, and if the measured temperatures are within the allowable range, the blowing agent is immediately injected, whereas if the measured temperatures are not within the allowable range, the temperatures are controlled to be within the allowable range by using the heat line and the fan 40 and then the blowing agent is injected.

As the blowing agent injected into the refrigerator cabinet 99 through the blowing agent injection opening 60, an icocyanate solution provided form a first tank 62, a resin or a polyol solution provided from a second tank 63 and water provided form a third tank 64 are mixed al a suitable ratio and then supplied to the refrigerator cabinet 99. The volume rate of flow (Q) of the blowing agent injected per unit time can be controlled by manipulating an opening/closing degree of the valves 62′, 63′ and 64′ installed at a connection pipe extending from each of the tanks 62-64. In addition, the temperature (TI) of the blowing agent can be controlled to come within the set allowable range by the heat line and the fan installed on each surface of the tanks 62-64 and near the tanks 62-64.

FIGS. 6 and 7 show that the temperature (Tc) of the refrigerator cabinet 99 is inferred from the temperature obtained by measuring the surface of the core unit 30 and the support unit 20 of the foaming device, but differently, the temperature (Tc) of the refrigerator cabinet 99 can be directly measured to be obtained. Namely, a relatively low-cost thermocouple can be embedded in the refrigerator cabinet 99 to directly measure the temperature inside the refrigerator cabinet 99. In this case, the thermocouple, namely, the temperature sensor, would be buried as the blowing foam is formed so it cannot be re-used, but if the thermocouple is constructed at a low cost, the temperature inside the refrigerator cabinet can be more accurately measured without increasing a production cost not very high, providing a better temperature environment.

The controller 80 previously stores the allowable range of the temperatures (TI and Tc) and the pressure (Pc) allowing the formation of the blowing foam with a uniform density distribution as set data in the database form obtained by experimentation or a computer simulation, and compares the measured values provided from the temperature and pressure sensors 71-75 with the stored allowable range to check whether they are within the stored allowable range. Upon comparison, only when the measured temperature values are all within the allowable range, the blowing agent can be injected into the refrigerator cabinet 99 through the blowing agent injection unit 60.

If, however, the measured temperature values are not within the allowable range, the controlling unit/units such as the heat line, the fan and the valves for controlling the temperatures (TI and Tc) or the pressure (Pc) is/are operated to control the temperatures (TI and Tc) or the pressure (Pc) so as to come within the allowable range. At the same time, a warning message is displayed through an alarming unit 90, so that an operator can easily recognize the operation state.

The process of forming the blowing foam within the refrigerator cabinet will now be described with reference to FIG. 7.

In the system 100 for forming foam within the refrigerator cabinet in which the allowable range of the parameters such as the temperature (Tc) within. the refrigerator cabinet 99, the temperature (TI) of the blowing agent and the volume rate of flow (Q) of the blowing agent allowing formation of blowing foam with the uniform density distribution through experimentation and computer simulation are inputted, set as data in the database form and stored, each of the support plates 21-25 of the system 100 is opened and the pre-assembled refrigerator 99 in a state that its inner and outer surfaces are attached with an empty space therebetween is insertedly installed in the system 100 (step S11)

Next, the support plates 21-25 of the foaming system 100 are closed, and then, the temperature (TI) of the blowing agent and the temperature (Tj) of the support unit 20 and the core unit 30 are measured to infer the temperature (Tc) of the refrigerator cabinet (step S13). The temperatures measured by the temperature sensors 71-74 is transmitted as an electrical signal to the controller 80. Then, the controller 80 checks whether the measured temperatures (TI and Tc) are within the allowable range set for allowing formation of the blowing foam with the uniform density distribution (step S13).

If the controller 80 determines that the measured temperatures (TI and Tc) are within the allowable range, the polyurethane blowing agent is injected into the refrigerator cabinet 99 through the blowing agent injection opening 25a of the foaming system 100 (step S15).

If, however, the controller determines that the temperatures (T1 and Tc) measured by the controller 80 are not within the set allowable range, the controller controls the temperatures to come within the allowable range by using the controlling unit such as the heat line or the fan (step S14).

For example, if the temperature (Tc) within the refrigerator cabinet 99 is lower than a lower limit value of the set allowable range, electricity flows to the heat line formed at the core unit 30 and the upper unit 20 to heat the refrigerator cabinet 99. While the refrigerator cabinet 99 is being heated, the temperatures (TI and Tc) are continuously measured to checks whether they come within the set allowable range. When the temperature (Tc) inside the refrigerator cabinet 99 is within the allowable range according to heating, the polyurethane blowing agent is injected into the refrigerator cabinet 99 through the blowing agent injection hole 25a of the foaming system 100 (step S15).

As the polyurethane blowing agent is injected into the refrigerator cabinet 99, the blowing agent is blown, and at this time, the pressure sensor 75 attached protrusively at the support unit 20 is inserted into the refrigerator cabinet 99 during the blowing process. In other words, when the refrigerator cabinet 99 is mounted in the foaming system 100 and hermetically closed, the pressure sensor 75 installed on the surface of the support unit 20 is inserted into a through hole formed at the outer surface of the refrigerator cabinet 99. In this case, by obtaining certain processing precision, the polyurethane blowing agent cannot be leaked through the through hole formed at the out surface of the refrigerator cabinet 99, and special coating is performed on the pressure sensor 75 so that the pressure sensor 75 can be easily separated from the polyurethane blowing agent. The pressure sensor 75 can be enough to be installed at one or two positions within the refrigerator cabinet 99, for measurement.

The pressure sensor installed within the refrigerator cabinet 99 measures pressure (Pc) during the blowing process and the controller 80 checks whether the pressure (Pc) is within the set allowable range in real time (step S16). If the measured pressure value (Pc) is not within the set allowable range, the controller 80 controls the opening/closing degree of the valves 62′, 63′ and 64′ controlling the volume rate of flow (Q) of the injection of the blowing agent to control the blowing pressure (Pc) within the refrigerator cabinet 99 to come within the allowable range in filling the urethane blowing foam (step S18).

Through the processes, the blowing foam can be distributed with uniform density within the refrigerator cabinet in the foaming system, and by forming the blowing foam with the uniform density, excellent insulation effect can be obtained.

As so far described, the method for forming foam with uniform density within a refrigerator cabinet to obtain excellent insulation (insulation) effect by feedback controlling and the foaming system used for the method in accordance with the present invention have many advantages.

That is, the allowable range of each of parameters, which critically affect the blowing foam quality of the refrigerator cabinet, allowing formation of the blowing foam with the uniform density within the refrigerator cabinet is obtained through experimentation and set in advance, and before forming the blowing foam within the refrigerator cabinet, each parameters are measured to check whether the measured value is within the allowable range. If the measured value does not come within the allowable range, it is controlled to come within the allowable range by using the controlling unit and the blowing foam is filled and formed within the refrigerator cabinet. By doing that, the reliable blowing foam with high quality and uniform density can be formed.

In addition, since the blowing foam is formed with the uniform density in advance, a defective rate when blowing is performed non-uniformly during the foamingprocess can be considerably reduced. Accordingly, only a refrigerator product having excellent insulation effect can be marketed, it can obtain good consumers' recognition for its quality.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for foaming of a refrigerator cabinet including a process of putting a refrigerator cabinet in a foaming device, injecting a blowing foam solution thereinto and blowing, comprising:
obtaining allowable range of a parameters with respect to securing good blowing foam quality of the refrigerator cabinet;
inputting and setting the allowable range of the parameters;
measuring the parameters with the refrigerator cabinet insertedly installed in the foaming device;
comparing a measured value of the parameters with the allowable range to check whether the measured value is within the allowable range of the parameters;
injecting a blowing agent into the refrigerator cabinet when the measured value of the parameters are within the allowable range; and
controlling the measured value of the parameters if it is not within the allowable range.

2. The method of claim 1, wherein if the measured value of the parameters are outside the allowable range in the comparing step, the measuring step is performed again.

3. The method of claim 2, wherein the parameters refers to one or more of temperature (Tl) of the blowing agent and temperature (Tc) of the refrigerator cabinet.

4. The method of claim 3, wherein the temperature (Tc) of the refrigerator cabinet is inferred temperature (Tj) of the foaming device contacting with the refrigerator cabinet.

5. The method of claim 4, wherein the foaming device comprises a core unit contacting with an inner surface of the refrigerator cabinet and a support unit contacting with an outer surface of the refrigerator cabinet, and the temperature (Tj) of the foaming device is measured from a surface of the support unit.

6. The method of claim 3, wherein the temperature (Tc) of the refrigerator cabinet is directly measured by a temperature sensor insertedly installed within the refrigerator cabinet.

7. The method of one of claim 3, wherein a heat line is formed on a surface of a blowing agent tank storing the blowing agent to supply it, and heated by applying a current thereto to control the temperature (Tl) of the blowing agent.

8. The method of one of claim 3, wherein a blowing fan is installed near the blowing agent storing the blowing agent to supply it and blows cold air to the blowing agent tank to control the temperature (Tl) of the blowing agent.

9. The method of one of claim 3, wherein a heat line is formed at a position contacting with the refrigerator cabinet, and heated by applying a current thereto to control the temperature (Tc) of the refrigerator cabinet.

10. The method of claim 1, wherein as for the allowable range, a range of the parameters for allowing formation of blowing foam with the uniform density through experimentation and computer simulation is stored as data in a database form.

11. The method of one of claim 3, wherein if the measured temperature is determined not to be within the set allowable range, a step of displaying a warning message informing that the measured temperature is not within the allowable range is additionally included.

12. The method of claim 3, further comprising:
measuring pressure (Pc) of the refrigerator cabinet after the step of injecting the blowing agent;
checking whether the measured pressure (Pc) is within the allowable range; and
controlling a volume rate of flow (Q) of the blowing agent injection unit when the measured pressure (Pc) is not within the allowable range.

13. A system for forming foam within a refrigerator cabinet by feedback controlling comprising:
a support unit for supporting an outer wall of the refrigerator cabinet;
a core unit for supporting an inner wall of the refrigerator cabinet;
a blowing agent injection unit for injecting a blowing agent into the refrigerator cabinet;
a temperature sensor installed at one of one surface of the support unit contacting with the outer wall of the refrigerator cabinet and one surface of the core unit contacting with the inner wall of the refrigerator cabinet;
a controller for checking whether a value measured by temperature sensor is within allowable range to obtain blowing foam quality of the refrigerator cabinet; and
a temperature controlling unit for controlling temperature within the refrigerator cabinet.

14. The system of claim 13, further comprising:
a blowing agent temperature sensor installed at the blowing agent injection unit to measure temperature (Tl) of the blowing agent and a temperature controlling unit for controlling the temperature (Tl) of the blowing agent;
wherein the controller compares the measured value of the blowing agent temperature sensor and the allowable range to check whether the measured value is within the allowable range, and if the measured value is not within the allowable range, the controller operates the temperature controlling unit.

15. The system of claim 13, further comprising:
a pressure sensor for measuring blowing pressure (Pc) within the refrigerator cabinet at a surface of the support unit and a blowing pressure controlling unit for controlling the blowing pressure (Pc).
wherein the controller compares the measured value of the pressure sensor with the allowable range to check whether the measured value is within the allowable range, and if the measured value is not within the allowable range, the controller operates the blowing pressure controlling unit.

16. The system of claim 15, wherein a through hole is formed at the refrigerator cabinet and the pressure sensor is formed to be protruded at one or more positions of a surface of the support unit and the core unit, so that when the refrigerator cabinet is installed in the foaming system, the pressure sensor can be positioned inside the refrigerator cabinet.

17. The system of claim 15, wherein the blowing pressure controlling unit is a valve for controlling an injection amount of the blowing agent per unit time.
